(19) United States
(12) Patent Application Publication
(10) Pub. No.: US 2016/0163272 A1
(43) Pub. Date: Jun. 9, 2016

(54) DISPLAY DEVICE

(71) Applicant: Japan Display Inc., Minato-ku (JP)

(72) Inventor: Nobuyuki ISHIGE, Tokyo (JP)

(73) Assignee: Japan Display Inc., Minato-ku (JP)

(21) Appl. No.: 14/953,948

(22) Filed: Nov. 30, 2015

(30) Foreign Application Priority Data
Dec. 5, 2014 (JP) 2014-246689

(51) Int. Cl. G09G 3/36; G09G 3/20

(52) U.S. Cl. CPC G09G 3/3607; G09G 3/3648; G09G 3/2003; G09G 2300/0404

(57) ABSTRACT

An area of a part of a peripheral region of a display region, where a transistor of an RGB switch is provided, is reduced, so that the area of the peripheral region of the display region is reduced. A display device includes a plurality of video signal lines. Each of the plurality of video signal lines has a first signal line connected to a first sub-pixel, a second signal line connected to a second sub-pixel, a first transistor connecting the first signal line to a signal line drive circuit, and a second transistor connecting the second signal line to the signal line drive circuit. Each of the first and second signal lines extends in the Y direction when seen in a plan view, and the first transistor includes an extending portion extending in a direction tilted with respect to the Y direction.

### CROSS-REFERENCE TO RELATED APPLICATION

The present application claims priority from Japanese Patent Application No. 2014-246689 filed on Dec. 5, 2014, the content of which is hereby incorporated by reference into this application.

### TECHNICAL FIELD OF THE INVENTION

The present invention relates to a display device. For example, the present invention relates to a technique effectively applied to a display device having video signal lines for supplying signals to a plurality of pixels arranged in a display region.

### BACKGROUND OF THE INVENTION

A display device displaying an image by supplying signals to a plurality of pixels arranged in a display region through a plurality of video signal lines is known. In such a display device, it is required to reduce an area of a peripheral region of the display region in order to downsize the display device and make the display region large.

Each of the plurality of pixels includes a plurality of sub-pixels that display each color of R (red), G (green), and B (blue), respectively. Each video signal line for supplying a video signal to each pixel includes a plurality of signal lines connected to the plurality of sub-pixels included in pixels, respectively. Each signal line connects an input unit, to which a video signal is inputted, to each sub-pixel. An RGB switching circuit is connected between the input unit and each signal line.

For example, Japanese Patent Application Laid-Open Publication No. 2012-234080 (Patent Document 1) describes a technique having a display device having an RGB switch that distributes a video voltage, outputted from a video line drive circuit, to a video line for a first-color sub-pixel, a video line for a second-color sub-pixel, and a video line for a third-color sub-pixel.

### SUMMARY OF THE INVENTION

The RGB switch in the above-described display device has a plurality of transistors connecting each of a plurality of signal lines to an input unit. The plurality of transistors are provided in a peripheral region of a display region.

However, since the plurality of sub-pixels are connected to each signal line, a relative large current flows through the transistor of the RGB switch which is connected to each signal line. Therefore, the channel width of the channel region of the transistor is made extremely larger than the channel length of the channel region, and therefore, the channel region of the transistor extends along the direction of extension of the signal line. In such a case, the lengthwise dimension of the peripheral region of the display region in the direction of extension of the signal line becomes large, and the area of the peripheral region of the display region cannot be reduced.

The present invention has been made in order to solve the problems of the conventional technique as described above, and has an object which provides a display device that reduces an area of an area of a portion where the transistor of the RGB switch is provided, which result is reduction in the area of the peripheral region of the display region.

The typical summary of the inventions disclosed in the present application will be briefly described as follows.

A display device according to one aspect of the present invention includes: a substrate; a plurality of pixels provided in a first region of the substrate on a main surface side; an input unit to which a video signal supplied to the plurality of pixels is inputted; and a plurality of video signal lines connecting the plurality of pixels to the input unit. Each of the plurality of pixels has a first sub-pixel and a second sub-pixel. Each of the plurality of video signal lines has a first signal line connected to the first sub-pixel, a second signal line connected to the second sub-pixel, a first switching element connecting the first signal line to the input unit, and a second switching element connecting the second signal line to the input unit. Each of the first and second switching elements is provided in a second region of the substrate on the main surface side. In a first direction when seen in a plan view, the second region is arranged closer to a first side than the first region. Each of the first and second signal lines extends in the first and second regions in the first direction when seen in a plan view, and the first switching element includes a first extending portion extending in a second direction tilted with respect to the first direction.

As another aspect thereof, the second region may include a third region and a fourth region arranged closer to the first region side than the third region. The first switching element may be provided in the third region, and the second switching element may be provided in the fourth region. At this time, the second switching element may extend in the first direction.

As still another aspect thereof, the second direction may be tilted with respect to the first direction toward a second side in the third direction crossing the first direction. The first switching element may include a second extending portion extending in the fourth direction tilted with respect to the first direction toward an opposite side of the second side in the third direction when seen in a plan view, and a first end on the first side of the second extending portion in the first direction may be connected to a second end on the opposite side of the first side of the first extending portion in the first direction.

As still another aspect thereof, the second region may include a fifth region and a sixth region arranged closer to the first region side than the fifth region. The first switching element may be provided in the fifth region, and the second switching element may be provided in the sixth region. At this time, the second switching element may extend in the first direction.

As still another aspect thereof, the first switching element may be a first thin-film transistor, the second switching element maybe a second thin-film transistor, and the first extending portion may be a first channel region.

As still another aspect thereof, the first switching element may be a third thin-film transistor, the second switching element may be a fourth thin-film transistor, the first extending portion may be a second channel region, and the second extending portion may be a third channel region.

As still another aspect thereof, the first sub-pixel may display a first color, and the second sub-pixel may display a second color different from the first color.

As still another aspect thereof, the input unit is provided in a seventh region on the main surface side of the substrate, and the seventh region may be arranged on an opposite side of the first region across the second region.

As still another aspect thereof, the first signal line may be connected to a first sub-pixel group formed of a plurality of first sub-pixels aligned in the first direction, and the second signal line may be connected to a second sub-pixel group formed of a plurality of second sub-pixels aligned in the first direction.

As still another aspect thereof, the display device may have a control unit that controls the state of connection between the first and second switching elements and the input unit. The control unit may perform control so that the first and second sub-pixel groups are selectively connected to the input unit by sequentially switching the first and second switching elements.

### BRIEF DESCRIPTIONS OF THE DRAWINGS

FIG. 1 is a plan view illustrating an example of a display device according to a first embodiment;

FIG. 2 is a cross-sectional view illustrating an example of the display device according to the first embodiment;

FIG. 3 is a cross-sectional view illustrating an example of the display device according to the first embodiment;

FIG. 4 is a diagram illustrating an equivalent circuit of the display device according to the first embodiment;

FIG. 5 is a diagram illustrating an equivalent circuit of a signal line and a transistor according to the first embodiment;

FIG. 6 is a plan view of the signal line and the transistor according to the first embodiment;

FIG. 7 is a cross-sectional view of the transistor according to the first embodiment;

FIG. 8 is a plan view of another example of the signal line and the transistor according to the first embodiment;

FIG. 9 is a plan view of a signal line and a transistor according to a comparative example;

FIG. 10 is a plan view of a transistor according to a comparative example;

FIG. 11 is a plan view of the transistor according to the first embodiment;

FIG. 12 is a plan view of still another example of the signal line and the transistor according to the first embodiment;

FIG. 13 is a plan view of a signal line and a transistor according to a second embodiment;

FIG. 14 is a plan view of another example of the signal line and the transistor according to the second embodiment;

FIG. 15 is a plan view of the transistor according to the second embodiment;

FIG. 16 is a plan view of another example of the transistor according to the second embodiment;

FIG. 17 is a plan view of still another example of the signal line and the transistor according to the second embodiment; and

FIG. 18 is a plan view of the transistor according to a modified example of the second embodiment.

### DESCRIPTIONS OF THE PREFERRED EMBODIMENTS

Hereinafter, each embodiment of the present invention will be described with respect to the drawings.

Note that the disclosure is merely one example, and appropriate modifications which can be easily thought up by those who skilled in the art are obviously included in the scope of the invention even in maintaining the concept of the invention. In order to make the description clear, the width, thickness, shape, etc., of each component are illustrated more schematically than those of the embodiments in some cases. However, they are merely an example, and do not restrict interpretation of the present invention.

In the present specification and each drawing, the same components as already described in the already-described drawings are denoted by the same reference numerals, and detailed description of the components may be appropriately omitted.

Also, in some drawings used in the embodiments, hatching may be omitted even in a cross-sectional view so as to make the drawings easy to see. Further, hatching may be used even in a plan view so as to make the drawings easy to see.

A technique to be described in the following embodiments can be applied widely to a display device having a mechanism that supplies signals from the periphery of a display region to a plurality of elements provided in the display region where a display function layer is formed. As the display device described above, various display devices such as a liquid crystal display device and organic EL (Electro-Luminescence) display device are exemplified. In the following embodiments, a liquid crystal display device will be exemplified and described as a typical example of the display device.

The liquid crystal display device is roughly classified into the following two classifications in accordance with a direction of application of an electric field for changing the orientation of liquid crystal molecules of a liquid crystal layer serving as the display function layer. That is, as the first classification, a so-called vertical electric field mode in which the electric field is applied in a thickness direction (out-of-plane direction) of the display device is cited. The vertical electric field mode includes, for example, a TN (Twisted Nematic) mode, a VA (Vertical Alignment) mode, and others. As the second classification, a so-called horizontal electric field mode in which the electric field is applied in a plane direction (in-plane direction) of the display device. The horizontal electric field mode includes, for example, an IPS (In-Plane Switching) mode, an FFS (Fringe Field Switching) mode which is one type of the IPS mode, and others. The technique to be described below is applicable to both of the vertical electric field mode and the horizontal electric field mode. However, in the embodiments to be described below, a display device having the horizontal electric field mode will be exemplified and described as an example.

### First Embodiment

<Configuration of Display Device>

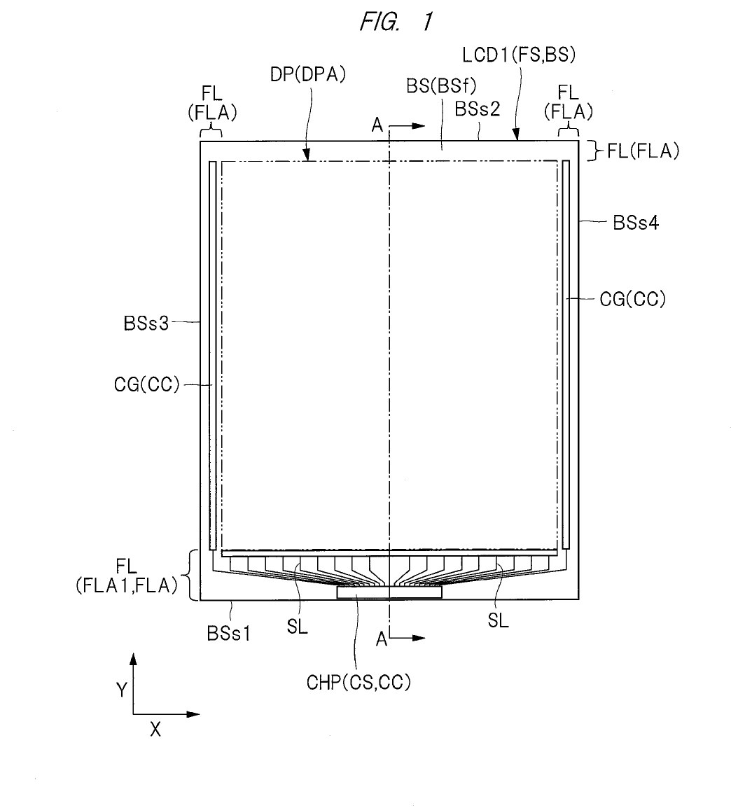

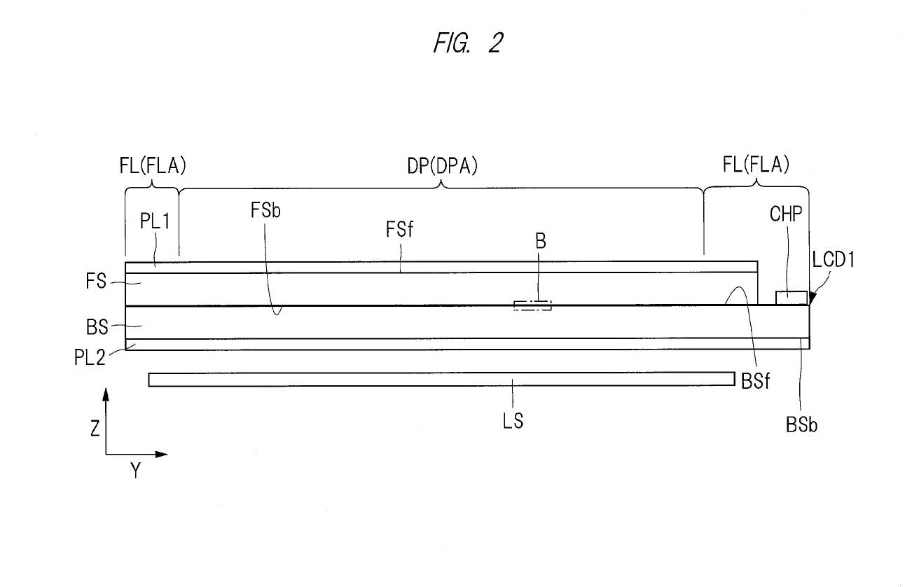

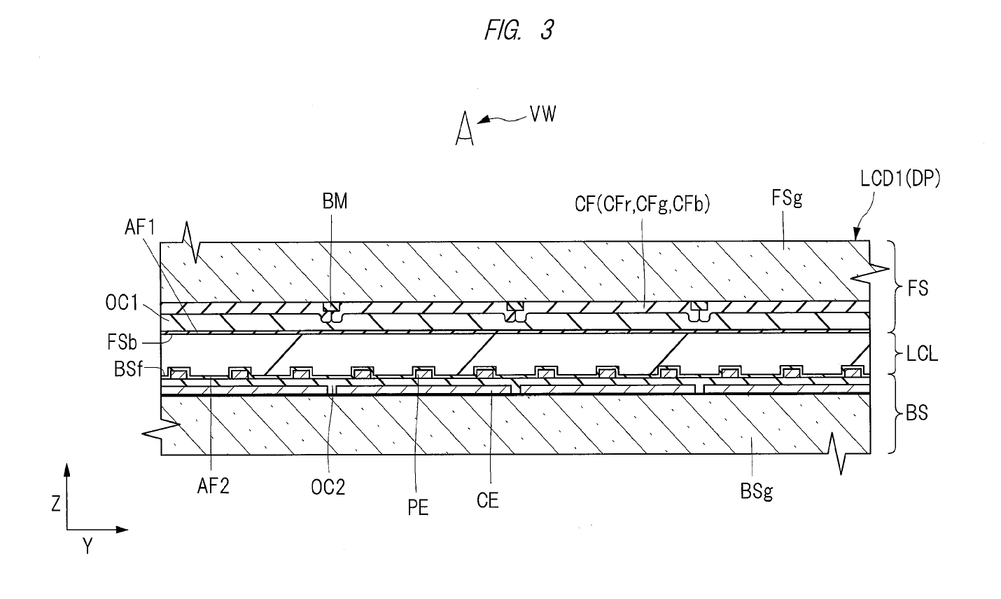

First, a configuration of the display device will be described. FIG. 1 is a plan view of an example of a display device according to a first embodiment. FIGS. 2 and 3 are cross-sectional views illustrating the example of the display device according to the first embodiment. FIG. 2 is a cross-sectional view taken along a line A-A of FIG. 1. FIG. 3 is an enlarged cross-sectional view of a “B” portion of FIG. 2.

Note that in FIG. 1, in order to easily see the boundary between a display region DPA and a frame region (peripheral region) FLA when seen in a plan view, the outline of the display region DPA is illustrated by a two-dot chain line. A plurality of video signal lines SL illustrated in FIG. 1 extend from the frame region FLA to the display region DPA. However, in order to easily see FIG. 1, illustration of the video signal lines SL are omitted in the display region DPA. Although FIG. 2 illustrates a cross section, hatching is omitted in order to easily see FIG. 2. The video signal line may be simply referred to as signal line.

As illustrated in FIG. 1, the display device LCD1 of the present first embodiment includes a display portion DP that displays an image. A region which is located on a front surface BSf side (see FIG. 2) serving as a main surface of a substrate BS and where the display portion DP is provided is a display region DPA. The display device LCD1 also includes a frame portion (peripheral portion) FL which is a frame-shaped portion in periphery of the display portion DP when seen in a plan view and on which an image is not displayed. A region in which the frame portion FL is formed is a frame region FLA. That is, while the frame region FLA is a frame-shaped region in periphery of the display region DPA, this is not limited to the frame shape.

In the specification of the present application, a wording “when seen in a plan view” means a case of a view in a direction perpendicular to the front surface BSf serving as the main surface of the substrate BS.

The display device LCD1 also includes a structure in which a liquid crystal layer serving as a display function layer is formed between a pair of opposed substrates. That is, as illustrated in FIG. 2, the display device LCD1 includes a substrate FS on a display surface side, a substrate BS located on an opposite side of the substrate FS, and a liquid crystal layer LCL arranged between the substrate FS and the substrate BS (see FIG. 3).

When seen in a plan view, the substrate BS of FIG. 1 includes a side BSs1 extending along an X direction, a side BSs2 extending along the X direction in parallel with the side BSs1, a side BSs3 extending along a Y direction crossing, more preferably, perpendicular to the X direction, and a side BSs4 extending along the Y direction in parallel with the side BSs3. Respective distances from the sides BSs2, BSs3, and BSs4 included in the substrate BS illustrated in FIG. 1 to the display portion DP are about the same as each other, and are shorter than a distance from the side BSs1 to the display portion DP.

Hereinafter, in the specification of the present application, the description “the peripheral edge of the substrate BS” means any one of the sides BSs1, BSs2, SBs3, and BSs4 making up the outer edge of the substrate BS. Also, the simple description “the peripheral edge” means the peripheral edge of the substrate BS.

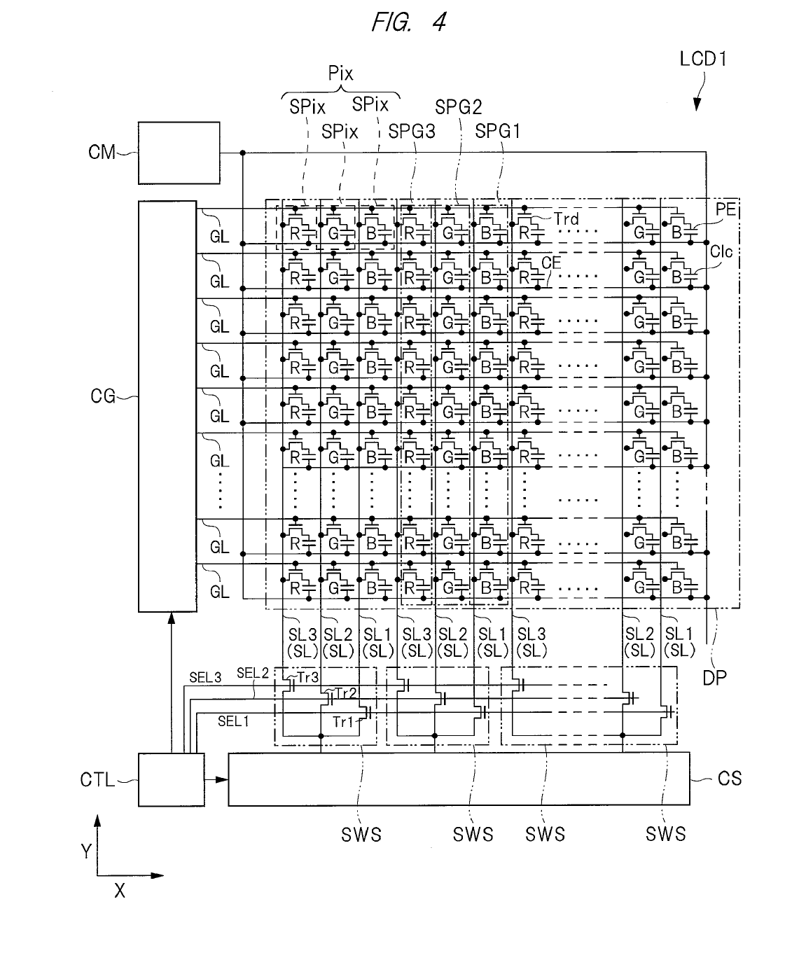

The display portion DP includes a plurality of pixels Pix (see FIG. 4 described later) serving as a plurality of display elements. That is, the plurality of pixels Pix are provided in the display region DPA. The plurality of pixels Pix are aligned in a matrix form in the X and Y directions. In the first embodiment, each of the plurality of pixels Pix has a thin-film transistor (TFT) formed in the display region DPA on the front surface BSf side serving as the main surface of the substrate BS.

The display device LCD1 includes a plurality of scanning lines GL and a plurality of signal lines SL as described later with reference to FIG. 4. As described later with reference to FIG. 4, each of the plurality of scanning lines GL is electrically connected to a plurality of pixels Pix arranged in the X direction, and each of the plurality of signal lines SL is electrically connected to a plurality of pixels Pix arranged in the Y direction.

The display device LCD1 also includes a circuit portion CC. The circuit portion CC includes a scanning line drive circuit CG and a signal line drive circuit CS. The scanning line drive circuit CG is electrically connected to the plurality of pixels Pix via the plurality of scanning lines GL, and the signal line drive circuit (the video signal line drive circuit) CS is electrically connected to the plurality of pixels Pix via the plurality of signal lines SL.

In the example illustrated in FIG. 1, a semiconductor chip CHP is provided in a frame region FLA1 which is a part of the frame region FLA between the side BSs1 of the substrate BS and the display portion DP. Inside the semiconductor chip CHP, the signal line drive circuit CS is provided. Therefore, the signal line drive circuit CS is provided in the frame region FLA1 which is the region on the front surface BSf side serving as the main surface of the substrate BS and which is the region arranged closer to a negative side than the display region DPA in the Y direction.

Note that the semiconductor chip CHP may be provided in the frame region FLA1 by using a so-called COG (Chip On Glass) technique, or may be provided outside the substrate BS and connected to the display device LCD1 via an FPC (Flexible Printed Circuit). The details of arrangement of the signal lines SL will be described later with reference to FIG. 4.

The display device LCD1 also includes a sealing portion formed in the frame region FLA when seen in a plan view. The sealing portion is so formed as to continuously surround the periphery of the display portion DP, and the substrates FS and BS illustrated in FIG. 2 are bonded and fixed to each other by a sealing material provided in the sealing portion. By providing the sealing portion in the periphery of the display portion DP as described above, the liquid crystal layer LCL serving as the display function layer (see FIG. 3) can be sealed.

As illustrated in FIG. 2, a polarizing plate PL2 that polarizes light generated from a light source LS is provided on the back surface BSb side of the substrate BS of the display device LCD1. The polarizing plate PL2 is fixed to the substrate BS. On the other hand, the polarizing plate PL1 is provided on the front surface FSf side of the substrate FS. The polarizing plate PL1 is fixed to the substrate FS.

Note that FIG. 2 exemplifies basic components for forming a display image. However, as a modification example, other components can be added in addition to the components illustrated in FIG. 2. For example, as a protective layer that protects the polarizing plate PL1 from scratches, dirt, etc., a protective film or cover member may be attached onto the front surface side of the polarizing plate PL1. Alternatively, for example, such an aspect as pasting an optical element such as a phase difference plate is applicable to the polarizing plate PL1 and the polarizing plate PL2. Alternatively, a method of forming a film of optical element is applicable to each of the substrates FS and BS.

As illustrated in FIG. 3, the display device LCD1 includes a plurality of pixel electrodes PE and a common electrode CE that are arranged between the substrate FS and the substrate BS. Because the display device LCD1 of the first embodiment is the display device having the horizontal electric field mode as described above, each of the plurality of pixel electrodes PE and the common electrode CE is formed on the substrate BS.

The substrate BS illustrated in FIG. 3 has a base material BSg made of a glass substrate, etc., and a circuit used mainly for image display is mainly formed on the base material BSg. The substrate BS has the front surface BSf located on the substrate FS side and the back surface BSb located on an opposite side of the front surface BSf (see FIG. 2). On the front surface BSf side of the substrate BS, display elements such as TFTs and the plurality of pixel electrodes PE are formed in a matrix form.

The example illustrated in FIG. 3 shows the display device LCD1 having the horizontal electric field mode (more specifically, FFS mode), and therefore, the common electrode CE is formed on the front surface side of the base material BSg included in the substrate BS, and is covered with an insulating layer OC2. The plurality of pixel electrodes PE are formed on the substrate FS side of the insulating layer OC2 so as to oppose the common electrode CE through the insulating layer OC2.

The substrate FS illustrated in FIG. 3 is a substrate obtained by forming a color filter CF for forming a color display image on the base material FSg made of a glass substrate, etc., and has the front surface FSf which is the display surface side (see FIG. 2) and the back surface FSb located on an opposite side of the front surface FSf. As seen in the substrate FS, a substrate having the color filter CF formed thereon is referred to as a color filter substrate or an opposite substrate because of opposing to a TFT substrate via a liquid crystal layer when the substrate is distinguished from the TFT substrate having the above-described TFT is formed thereon. As a modification example of FIG. 3, note that a configuration having the color filter CF provided on the TFT substrate may be applied.

In the substrate FS, the color filter CF is formed on, for example, one surface of the base material FSg made of a glass substrate, etc., the color filter being configured so that cyclically arranged color filter pixels CFr, CFg, and CFb for three colors of R (red), G (green), and B (blue) are periodically aligned. In a color display device, for example, one pixel is configured by taking the sub-pixels for the three colors of R (red), G (green), and B (blue) as one set. The plurality of color filter pixels CFr, CFg, and CFb of the substrate FS are arranged at positions opposing each sub-pixel having the pixel electrode PE formed on the substrate BS.

A light-shielding film BM is formed on each boundary among the color filter pixels CFr, CFg, and CFb for the respective colors. The light-shielding film BM is referred to as black matrix and is made of, for example, a black resin or a metal with low reflectivity. The light-shielding film BM is formed into a lattice form when seen in a plan view. In other words, the substrate FS has the color filter pixels CFr, CFg, and CFb for the respective colors that are formed in the openings of the lattice-shaped light-shielding film BM. Note that one pixel are not limited to be configured by three colors of R (red), G (green), and B (blue), and the colors may further include W (white) having a transparent filter or others. Also, the black matrix is not limited to the lattice shape, but may be formed in a stripe shape.

The frame region FLA is covered with the light-shielding film BM. The light-shielding film BM is formed also inside the display region DPA, and the plurality of openings are formed on the light-shielding film BM in the display region DPA. Generally, an end of the opening formed on a peripheral edge side among the openings formed on the light-shielding film BM and filled with the color filter CF is defined as the boundary between the display region DPA and the frame region FLA. Note that a dummy color filter may be provided to be closer to the peripheral edge side than the end of the opening.

The substrate FS has a resin layer OC1 covering the color filter CF. Since the light-shielding film BM is formed on the boundaries among the color filter pixels CFr, CFg, and CFb for the respective colors, the inner surface of the color filter CF has concave and convex surfaces. The resin layer OC1 functions as a flattening film that flattens the concave and convex of the inner surface of the color filter CF. Alternatively, the resin layer OC1 functions as a protective film that prevents an impurity from diffusing from the color filter CF to the liquid crystal layer. In the resin layer OC1, a resin material can be cured by containing a component therein such as heat-curing resin component and light-curing resin component cured by application of energy.

Between the substrate FS and the substrate BS, the liquid crystal layer LCL which forms a display image when a display voltage is applied between the pixel electrode PE and the common electrodes CE is formed. The liquid crystal layer LCL modulates light passing therethrough, in accordance with a state of the applied electric field.

The substrate FS also has an alignment film AF1, which covers the resin layer OC1, on the back surface FSb serving as an interface in contact with the liquid crystal layer LCL. The substrate BS has an alignment film AF2, which covers the insulating layer OC2 and the plurality of pixel electrodes PE, on the front surface BSf serving as an interface in contact with the liquid crystal layer LCL. These alignment films AF1 and AF2 are resin films formed for aligning the initial orientation of liquid crystals contained in the liquid crystal layer LCL, and are made of, for example, polyimide resin.

A method of displaying a color image by using the display device LCD1 illustrated in FIG. 3 is, for example, as follows. That is, light emitted out of the light source LS (see FIG. 2) is filtered by the polarizing plate PL2 (see FIG. 2), and light having passed through the polarizing plate PL2 enters the liquid crystal layer LCL. The light entering the liquid crystal layer LCL is propagated in the direction of thickness of the liquid crystal layer LCL (in other words, direction of traveling from the substrate BS to the substrate FS) while its polarization state is changed in accordance with refractive index anisotropy (in other words, Birefringence) of liquid crystals, and is emitted out of the substrate FS. At this time, the orientation of the liquid crystals is controlled by an electric field created by application of a voltage to the pixel electrodes PE and common electrodes CE, so that the liquid crystal layer LCL can function as an optical shutter. That is, in the liquid crystal layer LCL, light transmittance can be controlled for each sub-pixel. The light reaching the substrate FS is subjected to a color filtering process (that is, a process of absorbing light components other than a light component having a predetermined wavelength) at the color filter CF formed on the substrate FS, and is emitted out of the front surface FSf. Also, the light emitted out of the front surface FSf reaches a viewer VW through the polarizing plate PL1.

Not that the liquid crystal layer LCL has a thickness extremely smaller than each thickness of the substrate FS and of the substrate BS. The thickness of the liquid crystal layer LCL is about 0.1% to 10% of each thickness of the substrate FS and of the substrate BS. In the example illustrated in FIG. 3, the liquid crystal layer LCL has the thickness of, for example, about 3 μm to 4 μm.

<Equivalent Circuit of Display Device>

Next, an equivalent circuit of the display device will be described. FIG. 4 is a drawing illustrating an equivalent circuit of the display device according to the first embodiment.

As illustrated in FIG. 4, the display portion DP of the display device LCD1 has the plurality of pixels Pix. The plurality of pixels Pix are aligned in a matrix form in the X and Y directions.

The display device LCD1 includes the plurality of scanning lines GL and the plurality of signal lines SL. Each of the plurality of scanning lines GL extends in the X direction and is aligned in the Y direction. Each of the plurality of signal lines SL extends in the Y direction and is aligned in the X direction. The plurality of signal lines SL and the plurality of scanning lines GL intersect with each other.

Each of the plurality of pixels Pix includes sub-pixels SPix that display the R (red) color, G (green) color, and B (blue) color, respectively. Each sub-pixel SPix is provided in a region surrounded with two adjacent scanning lines GL and two adjacent signal lines SL, and two sub-pixels SPix maybe provided in the region surrounded with two adjacent scanning lines GL and the two adjacent signal lines SL.

Each sub-pixel SPix has a transistor Trd formed of a thin-film transistor, a pixel electrode PE connected to the drain electrode of the transistor Trd, and a common electrode CE opposing the pixel electrode PE across the liquid crystal layer. Note that a symbol “Clc” indicates a liquid crystal capacitor equivalently representing the liquid crystal layer. Further, in FIG. 4, illustration of a retention capacitor formed between the common electrode CE and the pixel electrode PE is omitted. Note that the drain electrode and the source electrode formed of the thin-film transistors are appropriately switched to each other depending on the polarities of potentials since the potentials with different polarities are supplied to the liquid crystal layer.

The display device LCD1 includes the signal line drive circuit CS, the scanning line drive circuit CG, a display control circuit CTL, and a common electrode drive circuit CM.

Each source electrode of the transistors Trd of the plurality of sub-pixels SPix aligned in the Y direction is connected to the signal line SL. Each of the plurality of signal lines SL is connected to the signal line drive circuit CS serving as the input unit to which a video signal, which is supplied to each sub-pixel SPix in accordance with display data, is inputted. That is, the plurality of signal lines SL connect the plurality of sub-pixels SPix to the signal line drive circuit CS.

Each gate electrode of transistors Trd of the plurality of sub-pixels SPix aligned in the X direction is connected to the scanning line GL. Each scanning line GL is connected to the scanning line drive circuit CG that supplies a scanning signal to each sub-pixel SPix for one horizontal scanning period.

The display control circuit CTL controls the signal line drive circuit CS, the scanning line drive circuit CG, and the common electrode drive circuit CM, based on display data transmitted from an external element and a display control signal such as a clock signal and a display timing signal.

The display control circuit CTL properly converts the externally-supplied display data and display control signal based on the arrangement of the sub-pixels of the display device, the display method, the presence/absence of a touch panel, or others, and outputs the converted data and signal to the signal line drive circuit CS, the scanning line drive circuit CG, and the common electrode drive circuit CM.

The signal line SL connected to each of the sub-pixels SPix has signal lines SL1, SL2, and SL3. They are connected to the RGB switching circuit SWS. The signal line SL1 is a signal line for B (blue) connected to the sub-pixel SPix displaying the B (blue) color. The signal line SL2 is a signal line for G (green) connected to the sub-pixel SPix displaying the G (green) color different from the B (blue) color. The signal line SL3 is a signal line for R (red) connected to the sub-pixel SPix displaying the R (red) color different from both B (blue) color and G (green) color.

Specifically, each of the signal lines SL1 displays the B (blue) color, and is connected to a sub-pixel group SPG1 formed of a plurality of sub-pixels SPix aligned in the Y direction. Each of the signal lines SL2 displays the G (green) color, and is connected to a sub-pixel group SPG2 formed of a plurality of sub-pixels SPix aligned in the Y direction. Each of the signal line SL3 displays the R (red) color, and is connected to a sub-pixel group SPG3 formed of a plurality of sub-pixels SPix aligned in the Y direction.

As described above, each of the plurality of signal lines SL extends in the Y direction and is aligned in the X direction. Therefore, each of the signal lines SL1, SL2, and SL3 extends in the Y direction. In the first embodiment, note that each of the sub-pixels SPix is provided in the region surrounded with two adjacent scanning lines GL and two adjacent signal lines of the signal lines SL1, SL2, and SL3.

The RGB switching circuit SWS is a selection unit that selectively connects any of the signal lines SL1, SL2, and SL3 to the signal line drive circuit CS. The RGB switching circuit SWS has transistors Tr1, Tr2, and Tr3 serving as switching elements. Each of the transistors Tr1, Tr2, and Tr3 is, for example, a thin-film transistor.

The transistor Tr1 connects the signal line SL1 for B (blue) to the signal line drive circuit CS. The transistor Tr2 connects the signal line SL2 for G (green) to the signal line drive circuit CS. The transistor Tr3 connects the signal line SL3 for R (red) to the signal line drive circuit CS.

The transistors Tr1, Tr2, and Tr3 are controlled by switching signals SEL1, SEL2, and SEL3 output from the display control circuit CTL, respectively. The transistor Tr1 is controlled to be switched on and off by the switching signal SEL1, the transistor Tr2 is controlled to be switched on and off by the switching signal SEL2, and the transistor Tr3 is controlled to be switched on and off by the switching signal SEL3.

Specifically, in the first period of one horizontal scanning period, the transistor Tr3 is switched on, and the transistors Tr2 and Tr1 are switched off, so that a video signal for R (red) outputted from the signal line drive circuit CS is outputted to the signal line SL3 for R (red). Next, in the second period of one horizontal scanning period, the transistor Tr2 is switched, and the transistors Tr3 and Tr1 are switched off, so that a video signal for G (green) outputted from the signal line drive circuit CS is outputted to the signal line SL2 for G (green). Next, in the third period of one horizontal scanning period, the transistor Tr1 is switched on, and the transistors Tr3 and Tr2 are switched off, so that a video signal for B (blue) outputted from the signal line drive circuit CS is outputted to the signal line SL1 for B (blue).

As described above, the signal line drive circuit CS supplies a video signal, which corresponds to the display data, to the video signal line SL for every horizontal scanning period.

That is, the display control circuit CTL is a control unit that controls the state of connection between each of the transistors Tr1, Tr2, and Tr3 and the signal line drive circuit CS. The display control circuit CTL sequentially switches the transistors Tr1, Tr2, and Tr3. In this manner, the display control circuit CTL performs controls so that the sub-pixel group SPG1 formed of the plurality of sub-pixels SPix displaying the B (blue) color, the sub-pixel group SPG2 formed of the plurality of sub-pixels SPix displaying the G (green) color, and the sub-pixel group SPG3 formed of the plurality of sub-pixels SPix displaying the R (red) color are connected selectively to the signal line drive circuit CS.

The display control circuit CTL controls the switching on/off of the transistors Tr1, Tr2, and Tr3 of the RGB switching circuit in synchronization with such control that the signal line drive circuit CS outputs a video signal for R (red), a video signal for G (green), and a video signal for B (blue) for one horizontal scanning period in time division. Further, during the period of outputting video signals for the respective colors, the scanning line drive circuit CG is controlled so as to maintain the switching-on state of the transistor Trd of the sub-pixel to which a video signal is written.

The RGB switching circuit may be simply referred to as RGB switch or referred to as signal line switch or time-division switch in some cases. In the present specification, note that one RGB switch circuit is provided for three signal lines connected to sub-pixels for red, green, and blue. However, one RGB switch circuit may be provided for two signal lines connected to two sub-pixels. Alternatively, one RGB switch circuit may be provided for six signal lines connected to two pixels, i.e., six sub-pixels. In this case, the signal line drive circuit outputs a video signal six times during one horizontal scanning period. The number of time divisions can be set appropriately depending on the writing status of the video signal to each sub-pixel and on the processing performance of the signal line drive circuit.

In this manner, for every horizontal scanning period, the scanning line drive circuit CG sequentially selects the scanning lines GL from top to bottom or from bottom to top, outputs the scanning signal supplied to the selected scanning line GL, conducts the transistors Trd of a plurality of sub-pixels SPix connected to the selected scanning line GL for one horizontal scanning period. Each video signal supplied to the signal lines SL1, SL2, and SL3 is outputted to the pixel electrode PE through the transistor Trd which is conducted for one horizontal scanning period, and electric charges are finally accumulated on the retention capacitor (not illustrated) and a liquid crystal capacitor Clc so as to control the orientation of liquid crystal molecules. In this manner, an image is displayed on the display portion DP.

<Signal Line and Transistor>

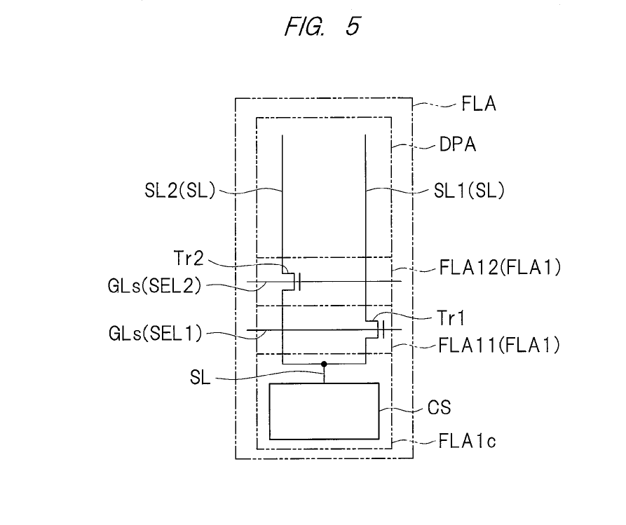

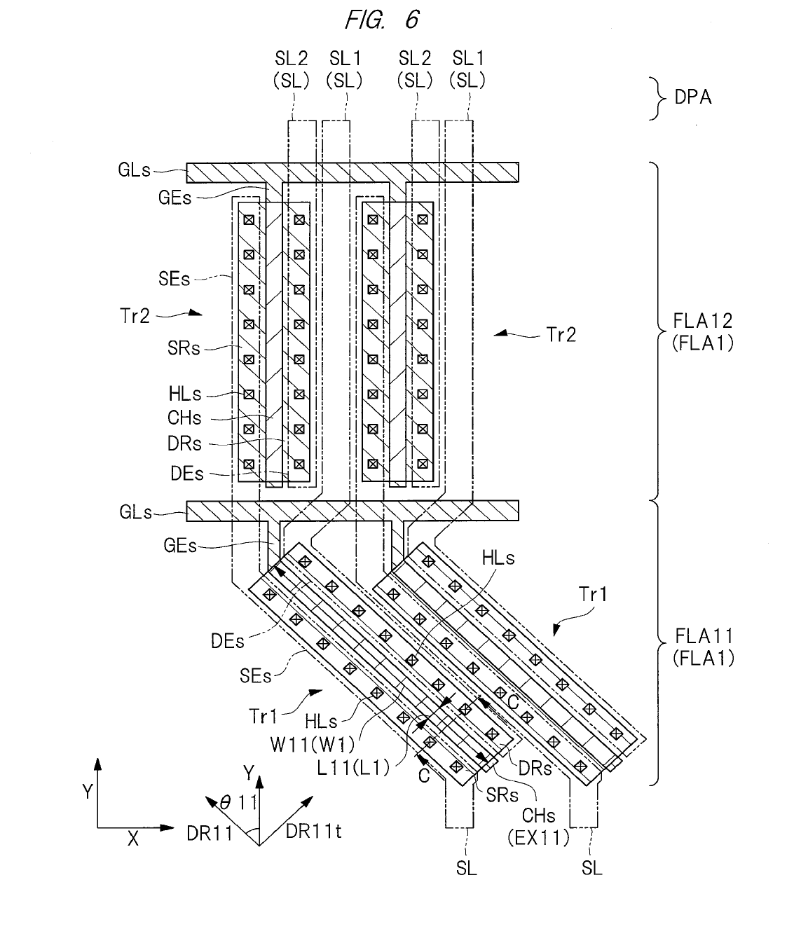

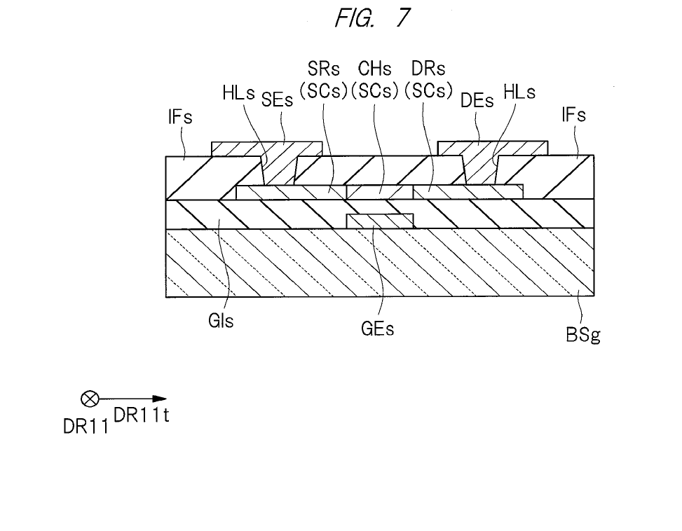

Next, arrangement of the signal lines and the transistors of the RGB switch will be described. FIG. 5 is the drawing illustrating an equivalent circuit of the signal lines and the transistors according to the first embodiment. FIG. 6 is a plan view of the signal lines and the transistors according to the first embodiment. FIG. 7 is a cross-sectional view of the transistor according to the first embodiment. FIG. 7 illustrates a cross-sectional view taken along a line C-C of FIG. 6.

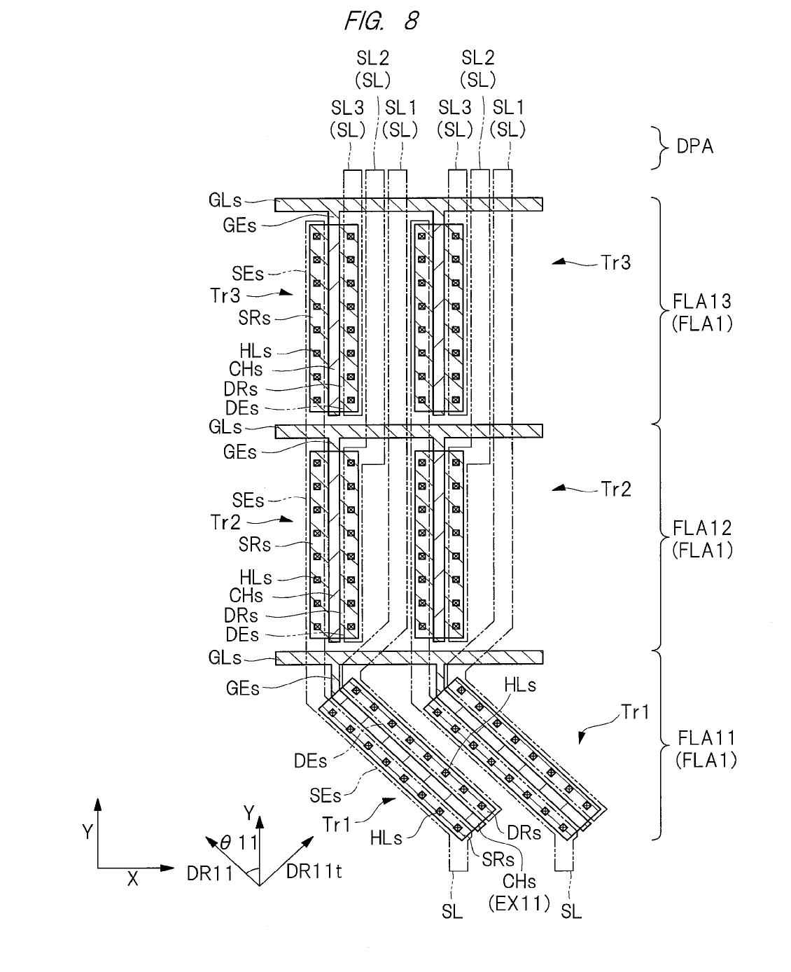

Hereinafter, note that a case of each pixel having, for example, sub-pixels SPix for two colors of B (blue) and G (green) will be exemplified and explained. However, when each pixel Pix has three sub-pixels Spix for R (red), G (green), and B (blue) as described above with reference to FIG. 4, each video signal line has the signal lines SL1, SL2, and SL3 and the transistors Tr1, Tr2, and Tr3 as described later with reference to FIG. 8.

In FIG. 6, the signal lines SL1 and SL2 are denoted by two-dot chain lines (other signal lines including the signal line SL3 are also the same in each plan view described below). In FIG. 7, illustration of an upper part than a source electrode SEs, a drain electrode DEs, and an exposed insulating film IFs is omitted.

In the example of FIG. 5, each of the plurality of video signal lines SL has the signal lines SL1 and SL2 and the transistors Tr1 and Tr2. The signal line SL1 is connected to the sub-pixels SPix for B (blue) (see FIG. 4). The signal line SL2 is connected to the sub-pixels SPix for G (green) (see FIG. 4). The transistor Tr1 connects the signal line SL1 to the signal line drive circuit CS (see FIG. 4). The transistor Tr2 connects the signal line SL2 to the signal line drive circuit CS (see FIG. 4). When the signal line drive circuit is formed of a semiconductor chip, a terminal, an anisotropic conductive sheet, a flexible wiring substrate, etc., may be intermediated between the transistors Tr1 and Tr2 and the signal line drive circuit in some cases. However, they are omitted.

Each of the transistors Tr1 and Tr2 is provided in the frame region FLA1, which is the region on the front surface BSf side (see FIG. 2) serving as the main surface of the substrate BS. The frame region FLA1 is arranged closer to the negative side of the frame region FLA in the Y direction, than the display region DPA.

The frame region FLA1 includes a frame region FLA11 and a frame region FLA12. The frame region FLA12 is arranged closer to the display region DPA side than the frame region FLA11. The transistor Tr1 is provided in the frame region FLA11, and the transistor Tr2 is provided in the frame region FLA12.

When the semiconductor chip CHP is provided in the frame region FLA1, note that the signal line drive circuit CS is arranged in a frame region FLA1c which is a region of the frame region FLA1 arranged on an opposite side of the display region DPA across the frame region FLA11.

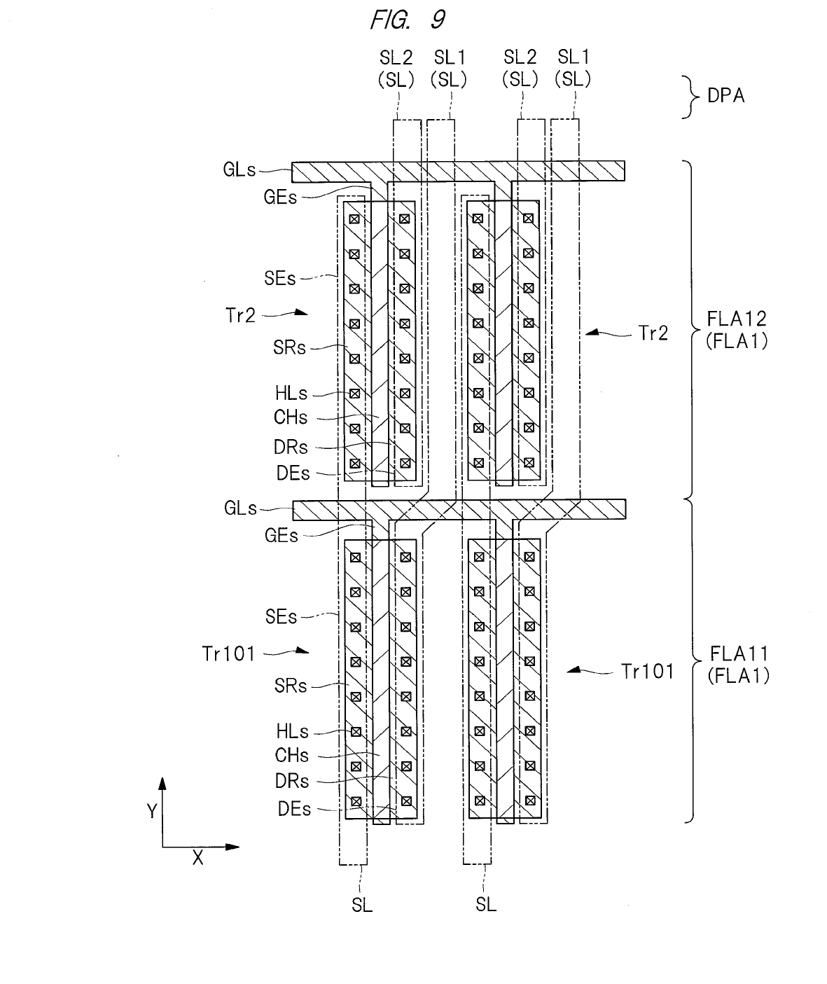

When seen in a plan view, the transistor Tr1 extends in a direction DR11 tilted with respect to the Y direction toward one side in the X direction such as the negative side in the X direction by an angle “θ11 ”. That is, the transistor Tr1 includes an extended portion EX11 extending in the direction DR11 tilted with respect to the Y direction toward the negative side in the X direction. In this manner, as described later with reference to FIGS. 9 to 11, the lengthwise dimension in the Y direction of the frame region FLA11 where the transistor Tr1 is arranged can be reduced.

In the present specification, note that the description “tilted with respect to a direction” means that an absolute value of an angle made with the direction is smaller than 90°.

In the example illustrated in FIG. 6, the transistor Tr2 extends in the Y direction. Alternatively, the transistor Tr1 may extend in the Y direction, and the transistor Tr2 may extend in the direction DR11. That is, in the first embodiment, when seen in a plan view, at least one of the transistors Tr1 and Tr2 extends in the direction DR11 tilted with respect to the Y direction in which the signal lines SL1 and SL2 extend. In this manner, the lengthwise dimension of the frame region FLA1 in the Y direction can be reduced.

As illustrated in FIG. 6, note that the signal line SL1 extending from the transistor Tr1 toward the display region DPA is arranged between the transistors Tr2. However, it is not required to provide the signal line extending toward the display region DPA between the transistors Tr1. Between the transistors Tr1, a margin as wide as the signal line exists. Therefore, the tilting of the transistor Tr1 with respect to the Y direction is easier to extend in, for example, the direction DR11, than the tilting of the transistor Tr2 with respect to the Y direction. If a margin exists between the transistors Tr2 and the signal line SL1, note that the transistor Tr2 can be tilted by an angle smaller than the angle θ11 by which the transistor Tr1 is tilted toward the Y direction. In this manner, the lengthwise dimension of the frame region FLA12 in the Y direction can also be reduced.

As illustrated in FIG. 7, the transistor Tr1 is a thin-film transistor, and has a gate electrode GEs, a gate insulating film GIs, a semiconductor layer SCs, the source electrode SEs, and the drain electrode DEs.

As illustrated in FIGS. 6 and 7, the gate electrode GEs is provided on a base material BSg. When seen in a plan view, the gate electrode GEs extends in the direction DR11. Also, the gate electrode GEs is extended from a gate wiring GLs toward, for example, the negative side in the Y direction. Each of the gate electrode GEs and the gate wiring GLs is made of a metal such as aluminum (Al) or molybdenum (Mo).

The gate insulating film GIs is so provided as to cover the gate electrode GEs. That is, the gate insulating film GIs is provided on the base material BSg so as to cover the gate electrode GEs. The gate insulating film GIs is a transparent insulating film made of, for example, silicon nitride or silicon oxide, etc.

When seen in a plan view, the semiconductor layer SCs is provided on the part of gate insulating layer GIs which overlaps the gate electrode GEs. The semiconductor layer SCs is made of, for example, amorphous silicon or polycrystalline silicon.

When seen in a plan view, the direction perpendicular to the direction DR11 is set to a direction DR11t. At this time, the semiconductor layer SCs is provided from an upper portion of the part of the gate insulating film GIs which is arranged on the negative side of the gate electrode GEs in the direction DR11t to an upper part of the part of gate insulating film GIs which is arranged on the positive side of the gate electrode GEs in the direction DR11t.

The part of semiconductor layer SCs which overlaps the gate electrode GEs when seen in a plan view is a channel region CHs. The part of semiconductor layer SCs which is arranged on the negative side of the gate electrode GEs in the direction DR11t is a source region SRs. The part of the semiconductor layer SCs which is arranged on the positive side of the gate electrode GEs in the direction DR11t is a drain region DRs. The source region SRs is in contact with the negative-side end of the channel region CHs in the direction DR11t, and the drain region DRs is in contact with the positive-side end of the channel region CHs in the direction DR11t.

The source electrode SEs of the transistor Tr1 is connected to the signal line drive circuit CS (see FIG. 4) via the signal line SL. The drain electrode DEs of the transistor Tr1 is connected to the signal line SL1.

Note that the source region SRs and the drain region DRs may be exchanged with each other, and the source electrode SEs and the drain electrode DEs may also be exchanged with each other (hereinafter, the transistor Tr2 and the transistor Tr3 may also be similarly described).

An insulating film IFs is so provided as to cover the channel region CHs, the source region SRs, the drain region DRs, and an exposed part of the gate insulating film GIs. The insulating film IFs is a transparent insulating film made of, for example, silicon nitride or silicon oxide, etc.

A contact hole HLs which penetrates through the insulating film IFs and which reaches the source region SRs is formed on the part of insulating film IFs which is positioned on the source region SRs, and a contact hole HLs which penetrates through the insulating film IFs and which reaches the drain region DRs is formed on the part of the insulating film IFs which is positioned on the drain region DRs. The source electrode SEs is formed inside the contact hole HLs and on the insulating film Ifs, and the drain electrode DEs is formed inside the contact hole HLs and on the insulating film IFs. The source electrode SEs is electrically connected to the source region SRs, and the drain electrode DEs is electrically connected to the drain region DRs. The drain electrode DEs is connected to the signal line SL1. Each of the source electrode SEs, the drain electrode DEs, and the signal line SL1 is made of, for example, a non-transparent metal such as aluminum (Al) or molybdenum (Mo).

In the example illustrated in FIG. 6, the channel region CHs of the transistor Tr1 extends in the direction DR11. That is, the extending portion EX11 of the transistor Tr1 is the channel region CHs. The length L11 of the channel region CHs in the direction DR11t is a channel length L1. The width W11 of the channel region CHs in the direction DR11 is a channel width W1. The channel width W1 is longer than the channel length L1.

As described above with reference to FIG. 4, the signal line SL1 is connected to the sub-pixel group SPG1 formed of the plurality of sub-pixels SPix aligned in the Y direction. Therefore, a relatively large current flows through the signal line SL1 and the transistor Tr1. Therefore, in the transistor Tr1, the channel width W1 of the channel region CHs is extremely larger than the channel length L1 of the channel region CHs.

Specifically, the channel length L1 of the channel region CHs can be set to be 3 μm to 10 μm, and the channel width W1 of the channel region CHs can be set to 200 μm.

Note that the transistor Tr2 can be structured as similar to the transistor Tr1 except for the extension in the Y direction different from the direction DR11 in which the transistor Tr1 extends when seen in a plan view. The Channel region CHs of the transistor Tr2 extends in the Y direction.

The source electrode SEs of the transistor Tr2 is connected to the source electrode SEs of the transistor Tr1 and the signal line drive circuit CS (see FIG. 4) via the video signal line SL. The drain electrode DEs of the transistor Tr2 is connected to the signal line SL2.

Further, in the transistor Tr2, the channel width of the channel region CHs is extremely larger than the channel length of the channel region CHs. The channel width of the channel region CHs of the transistor Tr2 can be set to be equal to the channel width W1 of the channel region CHs of the transistor Tr1, and the channel length of the channel region CHs of the transistor Tr2 can be set to be equal to the channel length L1 of the channel region CHs of the transistor Tr1.

FIG. 8 illustrates a case that each pixel Pix (see FIG. 4) has three sub-pixels SPix (see FIG. 4) and the RGB switching circuit SWS (see FIG. 4) has the transistor Tr3 in addition to the transistors Tr1 and Tr2. FIG. 8 is a plan view of another example of the signal lines and transistors according to the first embodiment. In the example illustrated in FIG. 8, the signal line SL3 is connected to the sub-pixels SPix for R (red) (see FIG. 4). The transistor Tr3 connects the signal line SL3 to the signal line drive circuit CS (see FIG. 4).

The frame region FLA1 includes a frame region FLA13 in addition to the frame regions FLA11 and FLA12. The frame region FLA13 is arranged closer to the display region DPA side than the frame region FLA12. The transistor Tr3 is provided in the frame region FLA13.

In the example illustrated in FIG. 8, the transistor Tr3 extends in the Y direction. Alternatively, when seen in a plan view, at least any one of the transistors Tr1, Tr2, and Tr3 may extend in the direction DR11 tilted with respect to the Y direction in which the signal lines SL1, SL2, and SL3 extend.

Also in FIG. 8, note that the signal line SL2 extending from the transistor Tr2 toward the display region DPA and the signal line SL1 extending from the transistor Tr1 toward the display region DPA are arranged between the transistors Tr3. Between the transistors Tr2, the signal line SL1 extending from the transistor Tr1 toward the display region DPA is arranged. However, between the transistors Tr1, it is not required to provide the signal line extending toward the display region DPA. A margin as large as a width of one signal line exists between the transistors Tr2 as compared with the transistors Tr3, and a margin as large as widths of two signal lines exists between the transistors Tr1. Therefore, the transistors Tr1 can extend in the direction DR11 tilted with respect to the Y direction by the angle θ11, and the transistors Tr2 can be tilted by an angle smaller than the angle θ11. In this manner, the lengthwise dimension of the frame region FLA12 in the Y direction can also be reduced.

Further, if a margin exists between the transistor Tr3 and the signal line, the transistor Tr3 can be tilted by an angle smaller than the tilt angle of the transistors Tr2. That is, by setting the tilt angles of the transistors in the channel length direction to be “tilt angle of the transistors Tr3<tilt angle of the transistors Tr2<tilt angle of the transistors Tr1”, the dimension of the frame region can be further reduced. In other words, a relation “dimension of the frame region FLA13 in the Y direction>dimension of the frame region FLA12 in the Y direction>dimension of the frame region FLA11 in the Y direction” is satisfied. In the present specification, note that the tilt or the tilt angle is based on the positive side in the Y direction (an arrow direction in the Y direction of the drawing).

The source electrode SEs of the transistor Tr3 is connected to the signal line drive circuit CS (see FIG. 4) via the source electrode SEs of the transistor Tr2, the source electrode SEs of the transistor Tr1, and the signal line SL. The drain electrode DEs of the transistor Tr3 is connected to the signal line SL3.

Further, in the transistor Tr3, the channel width of the channel region CHs is extremely larger than the channel length of the channel region CHs. The channel width of the channel region CHs of the transistor Tr3 can be set to be equal to the channel width W1 of the channel region CHs of the transistor Tr1, and the channel length of the channel region CHs of the transistor Tr3 can be set to be equal to the channel length L1 of the channel region CHs of the transistor Tr1.

Note that, for example, each of the plurality of pixels Pix (see FIG. 4) may include four or more sub-pixels SPix (see FIG. 4) for R (red), G (green), B (blue), W (white), etc., and each signal line SL may include four or more signal lines and four or more transistors.

<Lengthwise Dimension of Frame Area in Vertical Direction>

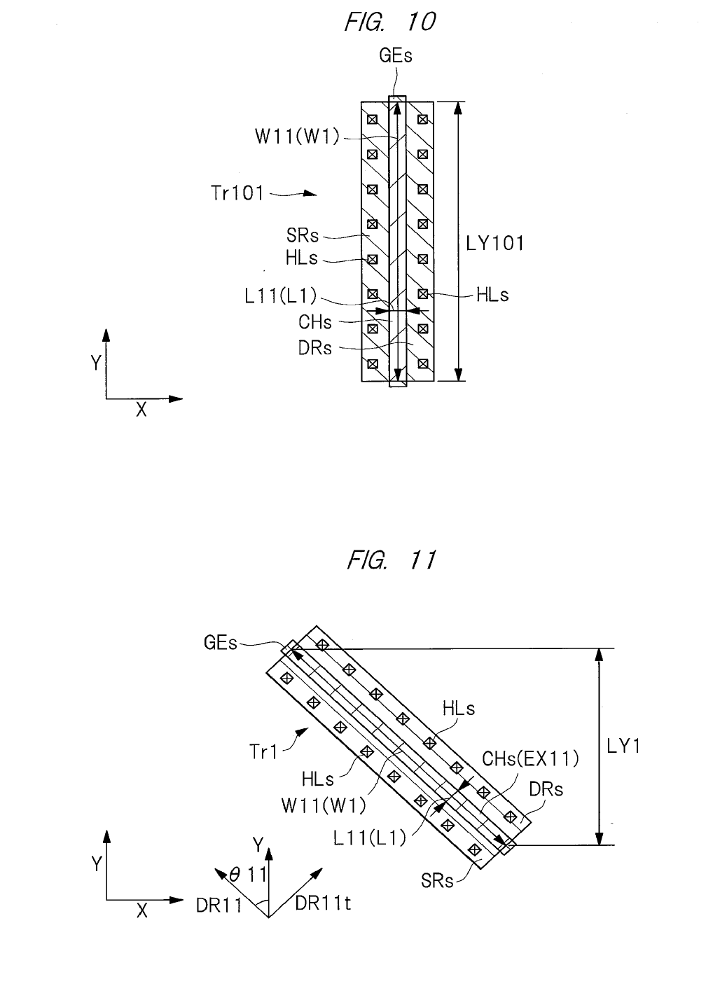

Next, the lengthwise dimension of the frame region FLA1 in the vertical direction (Y direction) will be described with reference to FIGS. 9 to 11 while being compared with that of a comparative example. FIG. 9 is a plan view of signal lines and transistors according to the comparative example. FIG. 10 is a plan view of the transistor according to the comparative example. FIG. 11 is a plan view of the transistor according to the first embodiment.

As illustrated in FIG. 9, in the comparative example, both of the transistor Tr2 and a transistor Tr101 provided in place of the transistor Tr1 of the first embodiment extend in the Y direction. That is, in the comparative example, directions of extension of both of the transistors Tr101 and Tr2 are not tilted with respect to the Y direction in which the signal lines SL1 and SL2 extend when seen in a plan view.

As illustrated in FIG. 10, in the transistor Tr101, the channel width W1 of the channel region CHs is extremely larger than the channel length L1 of the channel region CHs, and is, for example, 200 μm. In the comparative example, the lengthwise dimension LY101 of the transistor Tr101 in the Y direction is equal to the channel width W1. In such a case, the frame region FLA1, i.e., peripheral region of the display region DPA, has a large lengthwise dimension in the Y direction in which the signal lines SL1 and SL2 extend, and therefore, an area of the frame region FLA1 cannot be reduced.

On the other hand, in the first embodiment, for example, the transistor Tr1 extends in the direction DR11 tilted with respect to the Y direction when seen in a plan view. As illustrated in FIG. 11, when the transistor Tr1 extends in the direction DR11 tilted with respect to the Y direction by the angle θ11, the lengthwise dimension LY1 of the transistor Tr1 in the Y direction is reduced to be a value which is cos θ11 times the channel width W1. Therefore, in the first embodiment, the lengthwise dimension of the frame region FLA11 in the Y direction can be reduced to be a value which is cos θ11 times the lengthwise dimension of the comparative example. Therefore, in the first embodiment, an area of a part of the frame region FLA1, i.e., the peripheral region of the display region DPA, the part being provided with the transistor of the RGB switching circuit, can be reduced, and an area of the frame region FLA1 can be reduced.

In the present first embodiment, note that the channel width W1 can be maintained to be equal, and the current flowing through the transistor Tr1 can be maintained to be equal as compared with the comparative example. Therefore, the area of the frame region FLA1 can be reduced without deteriorating the characteristics of the display device.

In the present first embodiment, only the planar arrangement is changed as compared with the comparative example, and the cross-sectional structure is not changed. Therefore, a conventional manufacturing process can be applied as it is to the first embodiment.

When the direction DR11 is tilted with respect to the Y direction by the angle θ11, the widthwise dimension of the transistor Tr1 in the X direction is obtained by sin θ11, and therefore, the widthwise dimension of the transistor Tr1 in the X direction increases as increase in the angle θ11. However, by reducing a space between two adjacent transistors Tr1, the lengthwise dimension of the frame region FLA11 in the Y direction can be reduced without significant increase in the widthwise dimension of the frame region FLA11 in the X direction.

In FIG. 11, note that the case in which the absolute value of the angle θ11 is 45° has been exemplified and described. However, the absolute value of the angle θ11 is not limited to 45°. The absolute value of the angle θ11 is only required to be larger than 0° and smaller than 90°, and is more preferably equal to or larger than 15°. In this manner, the lengthwise dimension of the frame region FLA11 in the Y direction can be reduced to be equal to or smaller than a value which is cos 15° times the lengthwise dimension in the case of the absolute value of the angle θ11 being 0°, i.e., 0.97 times the lengthwise dimension in the case. More preferably, the absolute value of the angle θ11 is equal to or larger than 45°. In this manner, the lengthwise dimension of the frame region FLA11 in the Y direction can be reduced to be equal to or smaller than a value of cos 45° times the lengthwise dimension in the case of the absolute value of the angle θ11 being 0°, i.e., 0.71 times the lengthwise dimension in the case.

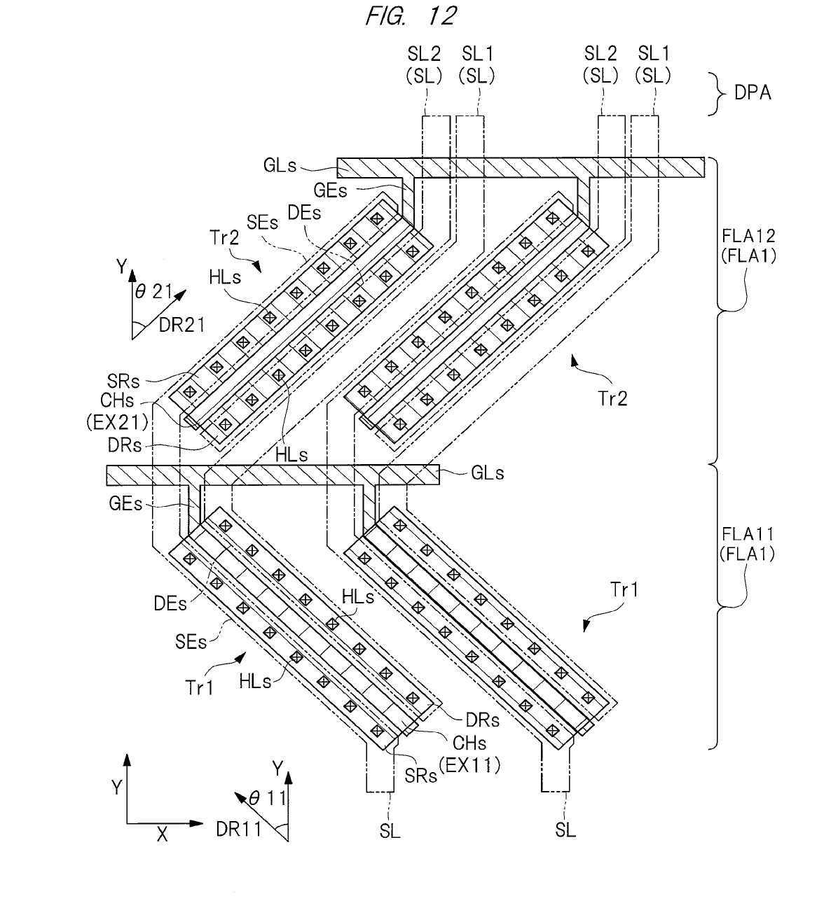

FIG. 12 is a plan view of another example of the signal lines and transistors according to the first embodiment. As illustrated in FIG. 12, as similar to the transistor Tr1, not only the transistor Tr1 but also the transistor Tr2 may also extend in a direction DR21 tilted with respect to the Y direction by only an angle θ21. That is, the channel region CHs of the transistor Tr2 is an extending portion EX21 extending in the direction DR21. In this manner, the lengthwise dimension of the frame region FLA12 in the Y direction can be reduced, and therefore, the lengthwise dimension of the frame region FLA1 in the Y direction can be reduced to be smaller than that of the example illustrated in FIG. 6.

However, in the frame region FLA12, the signal line SL1 is arranged between the transistors Tr2 adjacent to each other, and therefore, the signal line SL1 can be arranged easily in the frame region FLA12 by setting the angle θ21 to be smaller than the angle θ11 as described above with reference to FIG. 6.

The angles θ11 by which the plurality of transistors Tr1 included in the plurality of respective signal lines SL are tilted with respect to the Y direction may be equal to each other but may not be. For example, a case will be considered, the case applying the display device of the present first embodiment to such a deformed display that the side BSs2 extends in a direction tilted with respect to the X direction, and therefore, the side closer to the side BSs2 of the display region DPA extends in the direction tilted with respect to the X direction when the side BSs1 extends in the X direction and the sides BSs3 and BSs4 extends in the Y direction.

In such a case, the number of sub-pixels SPix connected to one signal line SL1 is different at each position in the X direction, that is, between the plurality of signal lines SL1. Therefore, the channel width W1 of the channel region CHs of the transistor Tr1 is different at each position in the X direction, that is, between the plurality of signal lines SL1. Therefore, by changing the angles θ11 at the respective positions in the X direction so as not to be equal to each other, the lengthwise dimensions LY1 of the transistors Tr1 in the Y direction can be equal to each other.

### Second Embodiment

In the first embodiment, the transistor Tr1 has the extending portion EX11 extending in the direction tilted with respect to the Y direction. On the other hand, in a second embodiment, the transistor Tr1 also has an extending portion EX12 bent and extending from an end of the extending portion EX11 in addition to the extending portion EX11.

Also in the second embodiment, a configuration and an equivalent circuit of the display device are the same as those of the first embodiment, and explanation for them is omitted.

<Signal Line and Transistor>

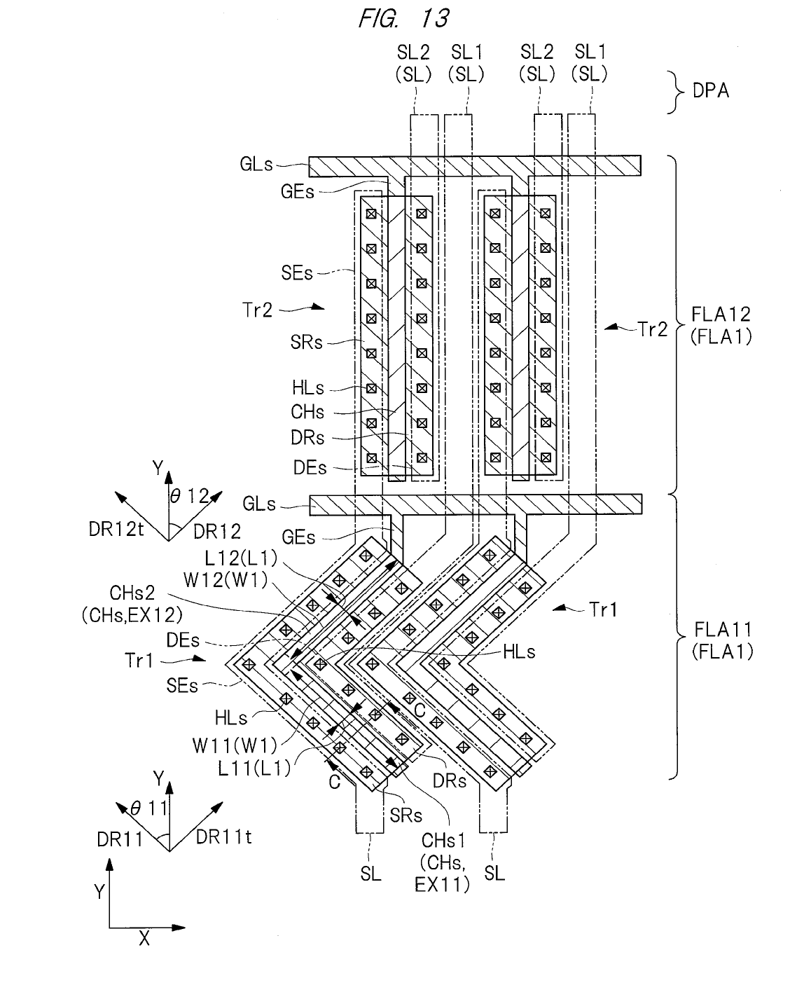

Next, arrangement of the signal lines and transistors will be described. FIG. 13 is a plan view of the signal lines and transistors according to the second embodiment.

Note that an equivalent circuit of the signal lines and transistors of the present second embodiment is the same as the equivalent circuit illustrated in FIG. 5. A cross-sectional structure taken along a C-C line of FIG. 13 is the same as the cross-sectional structure illustrated in FIG. 7.

Hereinafter, differences in the signal line and the transistor from the first embodiment will be mainly explained.

Each of the transistor Tr1 and the transistor Tr2 is provided in the frame region FLA1, which is the region on the front surface BSf side (see FIG. 2) serving as the main surface of the substrate BS. The frame region FLA1 is arranged closer to the negative side in the Y direction in the frame region FLA than the display region DPA.

The frame region FLA1 includes the frame region FLA11 and the frame region FLA12. The frame region FLA12 is arranged closer to the display region DPA side than the frame region FLA11. The transistor Tr1 is provided in the frame region FLA11, and the transistor Tr2 is provided in the frame region FLA12.

The transistor Tr1 includes the extending portion EX11 and the extending portion EX12. The extending portion EX11 extends in the direction DR11 tilted with respect to the Y direction toward the negative side in the X direction. The extending portion EX12 is bent and extends from the end of extending portion EX11 on the display region DPA side in a direction DR12 tilted with respect to the Y direction toward an opposite side of the negative side in the X direction, i.e., the positive side in the X direction when seen in a plan view. In other words, when seen in a plan view, the extending portion EX12 extends in the direction DR12 tilted with respect to the Y direction toward the opposite side of the negative side in the X direction, i.e., the positive side in the X direction, and the negative-side end of the extending portion EX12 in the Y direction is connected to the positive-side end of the extending portion EX11 in the Y direction.

In this manner, as described later with reference to FIG. 15, the lengthwise dimension of the frame region FLA11 in the Y direction where the transistor Tr1 is arranged can be reduced, and a degree of spread of the RGB switch in the X direction can be made smaller than that of the first embodiment. That is, in the second embodiment, the lengthwise dimension of the frame region FLA11 in the Y direction can be reduced without significantly increasing the widthwise dimension of the frame region FLA11 in the X direction.

In the example illustrated in FIG. 13, the transistor Tr2 extends in the Y direction. Alternatively, the transistor Tr1 may extend in the Y direction, and the transistor Tr2 may include the extending portion EX11 and the extending portion EX12. That is, in the second embodiment, at least either one of the transistor Tr1 and transistor Tr2 includes the extending portion EX11 and the extending portion EX12. In this manner, the lengthwise dimension of the frame region FLA1 in the Y direction can be reduced without significantly increasing the widthwise dimension of the frame region FLA1 in the X direction.

When seen in a plan view, the direction perpendicular to the direction DR11 is defined as the direction DR11t, and the direction perpendicular to the direction DR12 is defined as the direction DR12t. At this time, in the example illustrated in FIG. 13, a channel region CHs1 of the channel region CHs of the transistor Tr1 extends in the direction DR11, and a channel region CHs2 of the channel region CHs of the transistor Tr1 extends in the direction DR12. That is, the extending portion EX11 of the transistor Tr1 is the channel region CHs1, and the extending portion EX12 of the transistor Tr1 is the channel region CHs2.

Both of the length L11 of the channel region CHs1 in the direction DR11t and the length L12 of the channel region CHs2 in the direction DR12t have the channel length L1 of the channel region CHs. The sum of the width W11 of the channel region CHs1 in the direction DR11 and the width W12 of the channel region CHs2 in the direction DR12 have the channel width W1 of the channel region CHs. The channel width W1 is longer than the channel length L1.

Also in the second embodiment, as similar to in the first embodiment, the signal line SL1 is connected to the sub-pixel group SPG1 (see FIG. 4) formed of the plurality of sub-pixels SPix aligned in the Y direction. Therefore, a relatively large current flows through the signal line SL1 and the transistor Tr1. Therefore, in the transistor Tr1, the channel width W1 of the channel region CHs is extremely larger than the channel length L1 of the channel region CHs. Specifically, the channel length L1 of the channel region CHs can be set to 3 μm to 10 μm, and the channel width W1 of the channel region CHs can be set to 200 μm.

Note that the transistor Tr2 can be also the same as the transistor Tr1 except for the extension in the Y direction different from the direction DR11 in which the transistor Tr1 extends when seen in a plan view. The channel region CHs of the transistor Tr2 extends in the Y direction.

The source electrode SEs of the transistor Tr2 is connected to the signal line drive circuit CS (see FIG. 4) via the source electrode SEs of the transistor Tr1 and the video signal line SL. The drain electrode DEs of the transistor Tr2 is connected to the signal line SL2.

Further, in the transistor Tr2, the channel width of the channel region CHs is extremely larger than the channel length of the channel region CHs. The channel width of the channel region CHs of the transistor Tr2 can be equal to the channel width W1 of the channel region CHs of the transistor Tr1, and the channel length of the channel region CHs of the transistor Tr2 can be equal to the channel length L1 of the channel region CHs of the transistor Tr1.

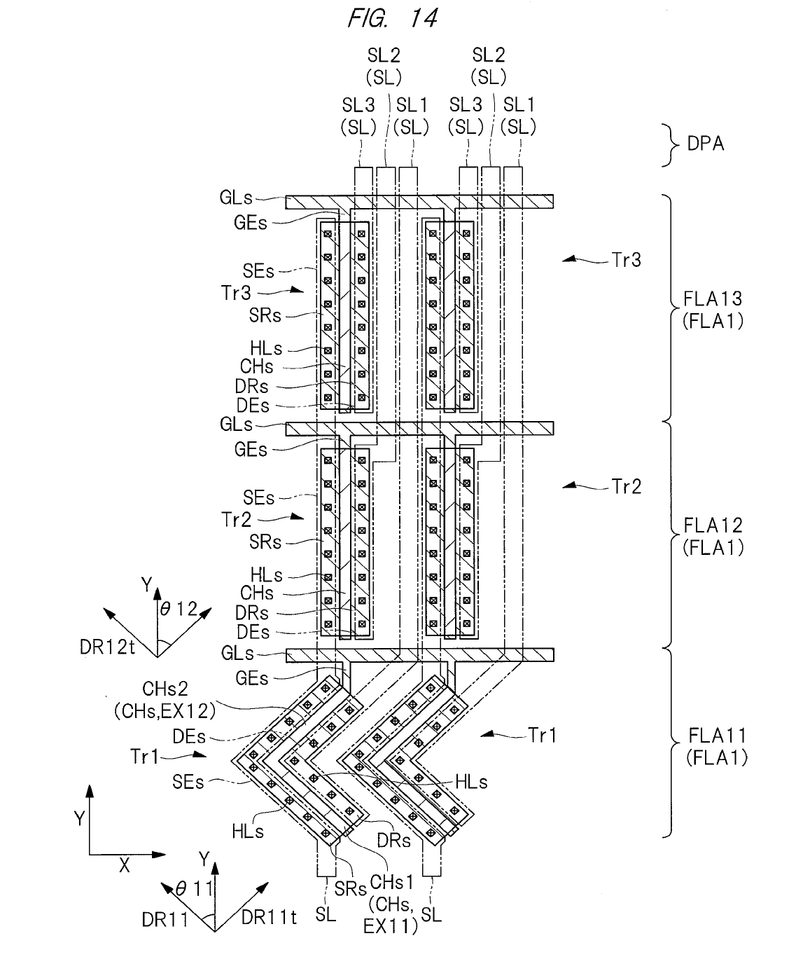

FIG. 14 illustrates a case that each pixel Pix (see FIG. 4) has three sub-pixels SPix (see FIG. 4) and the RGB switching circuit SWS (see FIG. 4) has the transistor Tr3 in addition to the transistors Tr1 and Tr2. FIG. 14 is a plan view of another example of the signal lines and transistors according to the second embodiment. In the example illustrated in FIG. 14, the signal line SL3 is connected to the sub-pixel SPix for R (red) (see FIG. 4). The transistor Tr3 connects the signal line SL3 to the signal line drive circuit CS (see FIG. 4).

The frame region FLA1 includes the frame region FLA13 in addition to the frame regions FLA11 and FLA12. The frame region FLA13 is arranged closer to the display region DPA side than the frame region FLA12. The transistor Tr3 is provided in the frame region FLA13.

In the example illustrated in FIG. 14, the transistor Tr3 extends in the Y direction. Alternatively, when seen in a plan view, at least any one of the transistors Tr1, Tr2, and Tr3 may include the extending portion EX11 extending in the direction DR11 and the extending portion EX12 extending in the direction DR12.

The source electrode SEs of the transistor Tr3 is connected to the signal line drive circuit (see FIG. 4) via the source electrode SEs of the transistor Tr2, the source electrode SEs of the transistor Tr1, and the signal line SL. The drain electrode DEs of the transistor Tr3 is connected to the signal line SL3.

Further, in the transistor Tr3, the channel width of the channel region CHs is extremely larger than the channel length of the channel region CHs. The channel width of the channel region CHs of the transistor Tr3 can be equal to the channel width W1 of the channel region CHs of the transistor Tr1, and the channel length of the channel region CHs of the transistor Tr3 can be equal to the channel length L1 of the channel region CHs of the transistor Tr1.

Note that, for example, each of the plurality of pixels Pix (see FIG. 4) may include four or more sub-pixels SPix (see FIG. 4) for R (red), G (green), B (blue), and W (white), etc., and each signal line SL may be formed of four or more signal lines and may include four or more transistors.

<Lengthwise Dimension of Frame Area in Vertical Direction >

Next, the lengthwise dimension of the frame region FLA1 in the vertical direction (Y direction) will be described with reference to FIG. 15 while being compared with that of the comparative examples of FIGS. 9 and 10. FIG. 15 is a plan view of the transistor according to the second embodiment.

As illustrated in FIG. 9, in the comparative example, both of the transistor Tr2 and the transistor Tr101 provided in place of the transistor Tr1 of the first embodiment extend in the Y direction. In the comparative example, the lengthwise dimension LY101 of the transistor Tr101 in the Y direction is equal to the channel width W1. In such a case, the lengthwise dimension of the frame region FLA1, i.e., of the peripheral region of the display region DPA in the Y direction in which the signal lines SL1 and SL2 extend is increased, and therefore, the area of the frame region FLA1 cannot be reduced.

On the other hand, in the second embodiment, for example, the transistor Tr1 includes the extending portion EX11 and the extending portion EX12. The extending portion EX11 extends in the direction DR11 tilted with respect to the Y direction toward the negative side in the X direction when seen in a plan view, the extending portion EX12 extends in the direction DR12 tilted with respect to the Y direction toward the positive side in the X direction when seen in a plan view.

As illustrated in FIG. 15, when the extending portion EX11 extends in the direction DR11 tilted with respect to the Y direction by the angle θ11, the lengthwise dimension LY11 of the channel region CHs1 serving as the extending portion EX11 in the Y direction is reduced to be a value of cos θ11 times the channel width W11. When the extending portion EX12 extends in the direction DR12 tilted with respect to the Y direction by an angle θ12, the lengthwise dimension LY12 of the channel region CHs2 serving as the extending portion EX12 in the Y direction is reduced to be a value of cos θ12 times the channel width W12. Therefore, in the second embodiment, the lengthwise dimension of the frame region FLA11 in the Y direction can be reduced to be shorter than that of the comparative example. Therefore, in the second embodiment, the area of the frame region FLA1, i.e., a part of the peripheral region of the display region DPA where the transistors of the RGB switching circuit is provided can be made smaller than that of the comparative example, and the frame region FLA1 can be made smaller.

Also in the second embodiment, as similar to the first embodiment, note that the area of the frame region FLA1 can be reduced without deteriorating the characteristics of the display device, and the conventional manufacturing process can be applied as it is.

When the direction DR11 is tilted with respect to the Y direction by only the angle θ11, the widthwise dimension of the channel region CHs1 serving as the extending portion EX11 in the X direction is obtained by sin θ11. When the direction DR12 is tilted with respect to the Y direction by only the angle θ12, the widthwise dimension of the channel region CHs2 serving as the extending portion EX12 in the X direction is obtained by sin θ12. However, in the second embodiment, the channel region CHs1 and the channel region CHs2 are tilted with respect to the Y direction toward opposite sides of each other, and therefore, the lengthwise dimension of the frame region FLA11 in the Y direction can be made smaller than that of the first embodiment without significantly increasing the widthwise dimension of the frame region FLA11 in the X direction.

In FIG. 15, note that the case in which the absolute value of the angle θ11 is 45° has been exemplified and described. However, the absolute value of the angle θ11 is not limited to 45°. It is only required that the absolute value of the angle θ11 is larger than 0° and smaller than 90°. However, preferably, the absolute value is equal to or larger than 15°. In this manner, the lengthwise dimension LY11 of the channel region CHs1 in the Y direction can be reduced to be equal to or smaller than a value of cos 15° times the lengthwise dimension in the case of the absolute value of the angle θ11 being 0°, i.e., 0.97 times the lengthwise dimension in the case. More preferably, the absolute value of the angle θ11 is equal to or larger than 45°. In this manner, the lengthwise dimension LY11 of the channel region CHs1 in the Y direction can be reduced to be equal to or smaller than a value of cos 45° times the lengthwise dimension in the case of the absolute value of the angle θ11 being 0°, i.e., 0.71 times the lengthwise dimension in the case.

In FIG. 15, the case in which the absolute value of the angle θ12 is 45° has been exemplified and described. However, the absolute value of the angle θ12 is not limited to 45°. It is only required that the absolute value of the angle θ12 is larger than 0° and smaller than 90°. However, preferably, the absolute value is equal to or larger than 15°. In this manner, the lengthwise dimension LY12 of the channel region CHs2 in the Y direction can be reduced to be equal to or smaller than a value of cos 15° times the lengthwise dimension in the case of the absolute value of the angle θ12 being 0°, i.e., 0.97 times the lengthwise dimension in the case. More preferably, the absolute value of the angle θ12 is equal to or larger than 45°. In this manner, the lengthwise dimension LY12 of the channel region CHs2 in the Y direction can be reduced to be equal to or smaller than a value of cos 45° times the lengthwise dimension in the case of the absolute value of the angle θ12 being 0°, i.e., 0.71 times the lengthwise dimension in the case.

In other words, the absolute value of an angle θ13 by which the direction DR12 is tilted with respect to the direction DR11 is preferably equal to or smaller than 150°, more preferably, equal to or smaller than 90°.

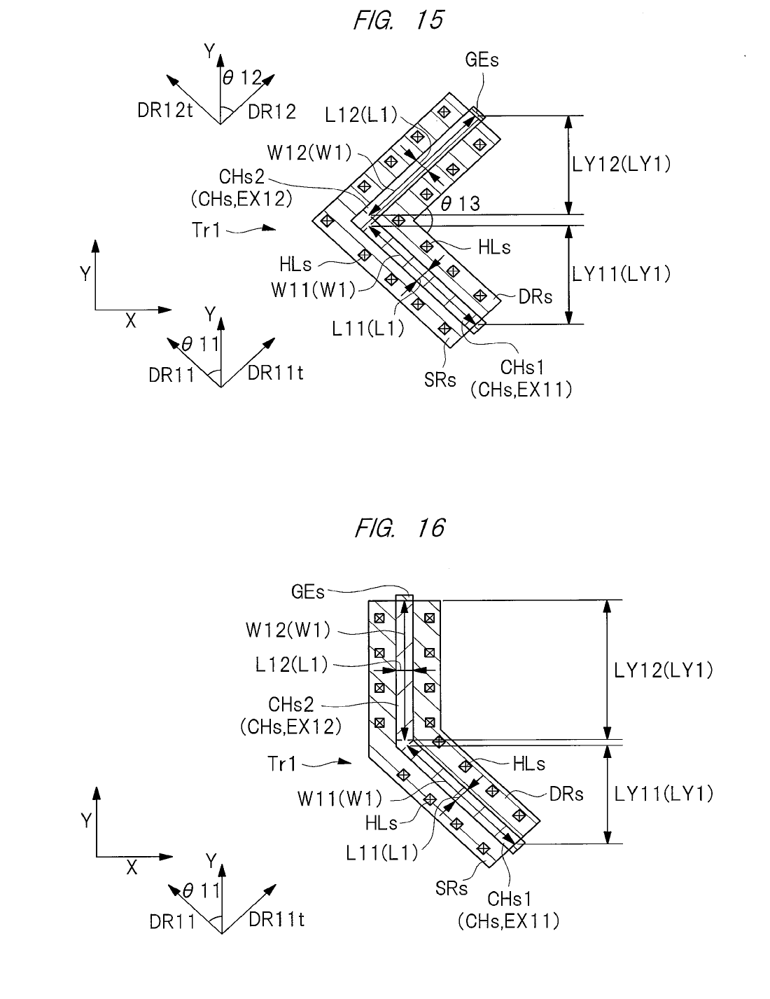

FIG. 16 is a plan view of another example of the transistor according to the second embodiment. As illustrated in FIG. 16, when seen in a plan view, the extending portion EX12 may extend in the Y direction without being tilted with respect to the Y direction. Also in such a case, at least the lengthwise dimension LY11 of the channel region CHs1 serving as the extending portion EX11 in the Y direction can be reduced.

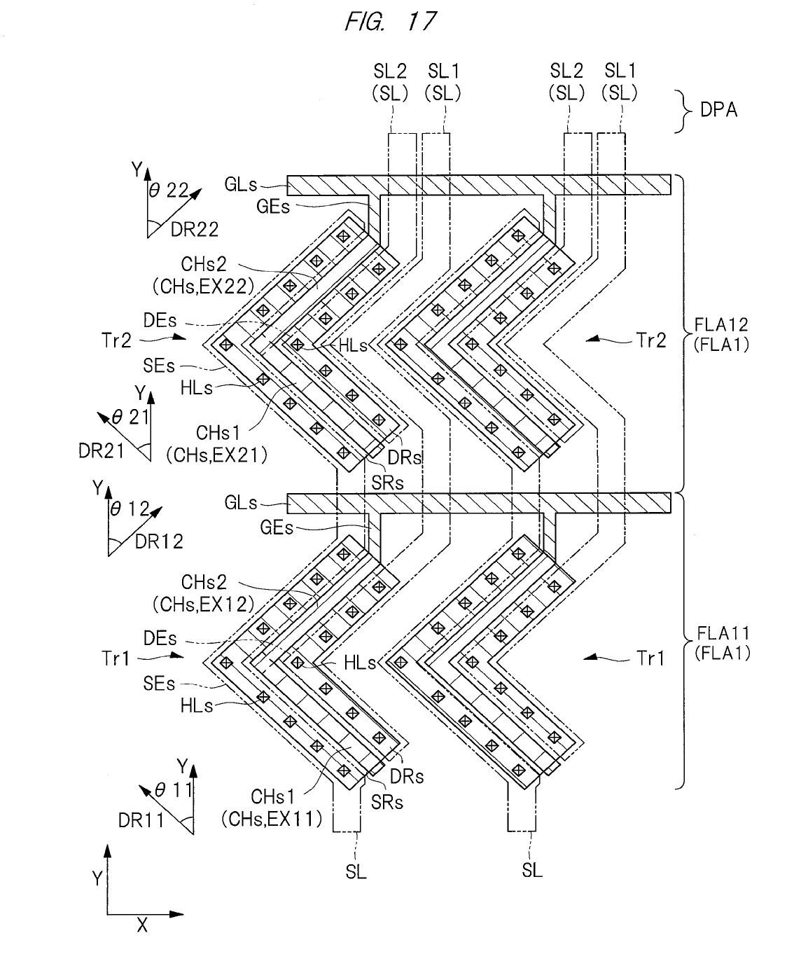

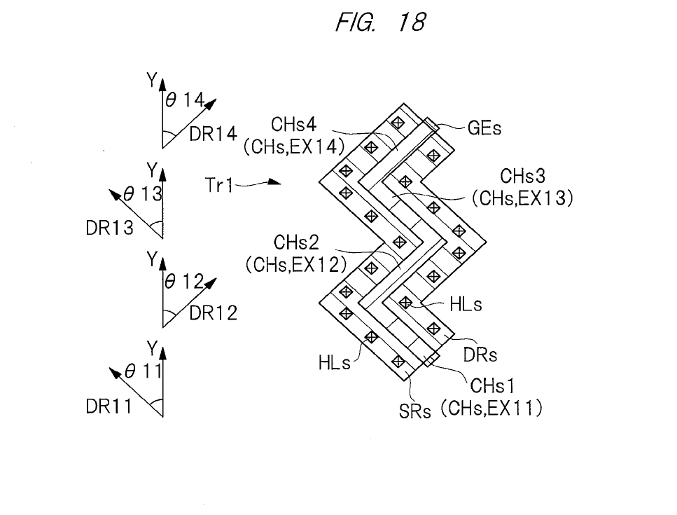

FIG. 17 is a plan view of still another example of the signal lines and transistors according to the second embodiment. As illustrated in FIG. 17, not only the transistor Tr1 but also the transistor Tr2 may include an extending portion EX21 and an extending portion EX22. Also, the channel region CHs1 serving as the extending portion EX21 may extend in a direction DR21 tilted with respect to the Y direction toward the negative side in the X direction by only an angle θ21, and the channel region CHs2 serving as the extending portion EX22 may extend in a direction DR22 tilted with respect to the Y direction toward the positive side in the X direction by only an angle θ22. In this manner, the lengthwise dimension of the frame region FLA12 in the Y direction can be reduced, and therefore, the lengthwise dimension of the frame region FLA1 in the Y direction can be made further smaller than that of the example illustrated in FIG. 13.

However, when it is desired to extend the signal line SL1 in the Y direction in the frame region FLA12, the signal line SL1 and the transistors Tr2 do not interfere with each other by the extension of the transistors Tr2 in the Y direction, as described above with reference to FIG. 13, and therefore, the signal line SL1 can be arranged easily in the frame region FLA12.

Alternatively, one of the transistor Tr1 and transistor Tr2 may have only the extending portion EX11, and the other of the same may have the extending portion EX11 and the extending portion EX12. Also in such a case, the lengthwise dimension of the frame region FLA1 in the Y direction can be made further smaller than that of the case illustrated in FIG. 13.

Note that the absolute value of the angle θ11 and the absolute value of the angle θ21 may be equal to each other or may not be. The absolute value of the angle θ12 and the absolute value of the angle θ22 may be equal to each other or may not be.

Alternatively, the angles θ11 and θ12 by which the plurality of transistors Tr1 included in the plurality of respective video signal lines SL are tilted with respect to the Y direction may be equal to each other or may not be. For example, when the display device of the second embodiment is applied to the deformed display described in the first embodiment, the number of sub-pixels SPix connected to one signal line SL1 is different between the plurality of signal lines SL1. Therefore, the channel width W1 of the channel region CHs of the transistor Tr1 is different between the plurality of signal lines SL1. Therefore, by making a difference in each of the angles θ11 and θ12 between the plurality of signal lines SL1 so that they are not equal to each other, the lengthwise dimensions LY1 of the transistors Tr1 in the Y direction can be equal to each other.

<Modification of Transistor>

FIG. 18 is a plan view of the transistor according to a modification example of the second embodiment. In FIG. 18, note that illustration of the source electrode SEs and the drain electrode DEs is omitted.

As illustrated in FIG. 18, the transistor Tr1 may extend in the Y direction as a whole while being bent alternately in opposite directions from each other. That is, the transistor Tr1 may have a zigzag shape when seen in a plan view.

In the example illustrated in FIG. 18, the transistor Tr1 includes the channel region CHs1 serving as the extending portion EX11, the channel region CHs2 serving as the extending portion EX12, a channel region CHs3 serving as the extending portion EX13, and a channel region CHs4 serving as the extending portion EX14.

The channel region CHs1 serving as the extending portion EX11 extends in the direction DR11 tilted with respect to the Y direction toward the negative side in the X direction. From the positive-side end of the channel region CHs1 serving as the extending portion EX11 in the Y direction, the channel region CHs2 serving as the extending portion EX12 is bent and extends in the direction DR12 tilted with respect to the Y direction toward the positive side in the X direction when seen in a plan view. From the positive-side end of the channel region CHs2 serving as the extending portion EX12 in the Y direction, the channel region CHs3 serving as the extending portion EX13 is bent and extends in a direction DR13 tilted with respect to the Y direction toward the negative side in the X direction when seen in a plan view. From the positive-side end of the channel region CHs3 serving as the extending portion EX13 in the Y direction, the channel region CHs4 serving as the extending portion EX14 is bent and extends in a direction DR14 tilted with respect to the Y direction toward the positive side in the X direction when seen in a plan view.

In this manner, also in the present embodiment, as similar to the second embodiment, the lengthwise dimension of the frame region FLA11 (see FIG. 13) in the Y direction where the transistor Tr1 is arranged can be reduced.

On the other hand, the present modification example has the zigzag shape, so that the widthwise dimension of the transistor Tr1 in the X direction can be reduced. Therefore, the widthwise dimension of the frame region FLA11 (see FIG. 13) in the X direction can be made further smaller than that of the second embodiment. In the present modification example and the second embodiment, note that the shape of the channel region in the bent portion is different from the shape of other regions. Therefore, the semiconductor in the bent portion may be eliminated. Conversely, either or both of the source electrode and the drain electrode in the bent portion may be eliminated.

In the foregoing, the invention made by the present inventor has been concretely described based on the embodiments. However, it is needless to say that the present invention is not limited to the foregoing embodiments and various modifications and alterations can be made within the scope of the present invention.

For example, when difference in the direction of extension of the transistor Tr1 is made between the extending portions EX11 and EX12, difference in the tilt angle of the extension direction may be made between the extending portions EX11 and EX12. While the channel region CHs1 and the channel region CHs2 are equal to each other in the length, one length may be different from the other. The same goes for each extending portion of the example of FIG. 18. When the transistor Tr1 has the extending portions EX11 and EX12 and the transistor Tr2 has the extending portions EX21 and EX22, the tilt angles of the extending portions EX21 and EX22 may be made smaller than the tilt angles of the extending portions EX11 and EX12 in consideration of the arrangement of signal lines. The RGB switches are provided over the whole of the frame region FLA1 in the X direction. However, it is not required to form all the transistors so as to have the same shape as each other, and therefore, in consideration of wiring density, etc., only some transistors may be formed as the embodiments of the invention of the present application, or the embodiments of the invention of the present application may be combined with each other depending on a location for the arrangement.

In the above-described embodiments, the case of the liquid crystal display device has been exemplified as the disclosure example. However, as another application example, many types of flat-panel display devices such as an organic EL display device, other self-luminous type display device, and an electronic-paper type display device having an electrophoretic element can be exemplified. And, it is needless to say that the present invention is applicable to display devices ranging from small- or middle-sized one to large one without any particular limitation.

Various modification examples and alteration examples can be thought up by those who skilled in art in the scope of the concept of the present invention, and it will be understood that these modification examples and alteration examples also belong to the scope of the present invention.

For example, the appropriate addition of the component to, elimination of the component from, or design change of the component from each embodiment described above by those who skilled in art, or addition of the process, omitting of the process, or condition change are also included in the scope of the present invention as long as the gist of the present invention is provided. Such modifications or alterations are also included in the scope of the present invention as far as they embody the substance of the invention.

The present invention is effectively applied to a display device.

What is claimed is:

1. A display device comprising:
a substrate;
a plurality of pixels provided in a first region of the substrate on a main surface side;
an input unit to which a video signal supplied to the plurality of pixels is inputted; and
a plurality of video signal lines connecting the plurality of pixels to the input unit,
wherein each of the plurality of pixels has:
a first sub-pixel; and
a second sub-pixel,
each of the plurality of video signal lines has:
a first signal line connected to the first sub-pixel;
a second signal line connected to the second sub-pixel;
a first switching element connecting the first signal line to the input unit; and
a second switching element connecting the second signal line to the input unit,
each of the first switching element and the second switching element is provided in a second region of the substrate on the main surface side,
in a first direction when seen in a plan view, the second region is arranged closer to a first side than the first region,
each of the first signal line and the second signal line extends in the first region and the second region in the first direction when seen in a plan view, and
the first switching element includes a first extending portion extending in a second direction tilted with respect to the first direction.

2. The display device according to claim 1,
wherein the second region includes:
a third region; and
a fourth region arranged closer to the first region side than the third region,
the first switching element is provided in the third region, and
the second switching element is provided in the fourth region.

3. The display device according to claim 2,
wherein the second switching element extends in the first direction.

4. The display device according to claim 1,
wherein the second direction is tilted with respect to the first direction toward a second side in the third direction crossing the first direction,
the first switching element includes a second extending portion extending in a fourth direction tilted with respect to the first direction toward an opposite side of the second side in the third direction when seen in a plan view, and
a first end on the first side of the second extending portion in the first direction is connected to a second end on an opposite side of the first side of the first extending portion in the first direction.

5. The display device according to claim 4,
wherein the second region includes:
a fifth region; and
a sixth region arranged closer to the first region side than the fifth region,
the first switching element is provided in the fifth region, and
the second switching element is provided in the sixth region.

6. The display device according to claim 5,
wherein the second switching element extends in the first direction.

7. The display device according to claim 1,
wherein the first switching element is a first thin-film transistor,
the second switching element is a second thin-film transistor, and
the first extending portion is a first channel region.

8. The display device according to claim 4,
wherein the first switching element is a third thin-film transistor,
the second switching element is a fourth thin-film transistor,
the first extending portion is a second channel region, and
the second extending portion is a third channel region.

9. The display device according to claim 1,
wherein the first sub-pixel displays a first color, and
the second sub-pixel displays a second color different from the first color.

10. The display device according to claim 1,
wherein the input unit is provided in a seventh region of the substrate on the main surface side, and
the seventh region is arranged on an opposite side of the first region across the second region.

11. The display device according to claim 1,
wherein the first signal line is connected to a first sub-pixel group formed of a plurality of the first sub-pixels aligned in the first direction, and
the second signal line is connected to a second sub-pixel group formed of a plurality of the second sub-pixels aligned in the first direction.

12. The display device according to claim 11,
wherein the display device has a control unit that controls a state of connection between the first and second switching elements and the input unit, and
the control unit performs control so that the first sub-pixel group and the second sub-pixel group are selectively connected to the input unit by sequentially switching the first switching element and the second switching element.
